(19) United States
(12) Patent Application Publication
(10) Pub. No.: US 2014/0209039 A1
(43) Pub. Date: Jul. 31, 2014

(54) Bark Control Device

(71) Applicants: Anson Wong, Boca Raton, FL (US); Kim Wah Chung, Shatin (HK); Gabriel S. Kohn, Boca Raton, FL (US)

(72) Inventors: Anson Wong, Boca Raton, FL (US); Kim Wah Chung, Shatin (HK); Gabriel S. Kohn, Boca Raton, FL (US)

(21) Appl. No.: 14/234,029

(22) PCT Filed: Aug. 1, 2012
(86) PCT No.: PCT/US12/49105

§ 371 Date: Apr. 9, 2014

Related U.S. Application Data
(60) Provisional application No. 61/515,003, filed on Aug. 4, 2011.

(51) Int. Cl. A01K 15/02

(52) U.S. Cl. CPC A01K 15/022
USPC 119/718

(57) ABSTRACT

A collar mounted bark control device which is positionable about the neck of a dog. The bark control device includes a collar with a housing mounted thereto. The housing contains a power source such as a battery or the like. Microphones are positioned on the housing for detecting the sound produced by the dog while barking. A processing unit (CPU) is provided for receiving the signals from the microphones for making a bark determination. A corrective stimulus is applied to the dog when the CPU makes a positive bark determination. The corrective stimulus can be provided by a pair of electrodes for applying an electroshock to the neck of the dog. Alternatively, the corrective stimulus can be provided by a high frequency emitter, a vibration., a spray, an audible deterrent, or an irritant to the dog.

### FIELD OF THE INVENTION

The invention relates to a system and device for controlling the barking of pet dogs. More specifically, the preset invention relates to a device worn about the neck of the dog to provide a corrective stimulus to the dog when barking.

### BACKGROUND OF THE INVENTION

Training devices are often used to modify the behavior on a animal such as a dog. Such training devices can take the form a collar having a stimulus device worn by the dog. The stimulus device can provide a corrective stimulus to the dog upon the detection of an undesirable behavior.

One class of such training device is a bark control device which is used to correct the undesirable behavior of continual barking by a dog. Such bark control devices can include a system for determining when a dog is barking. Upon which, a corrective stimulus is provided to the dog. The corrective stimulus can take the form of an electrostatic shock, an ultrasonic pulse, an irritant, a vibration, a spray, and an audible deterrent.

### SUMMARY OF THE INVENTION

The preset invention provides a bark control device for training a dog not to bark. The bark control device includes a housing mountable about the neck of the dog. A bark determination system is carried by the housing for determining if a sound is a bark. A stimulus delivery device is also carried by the housing and is responsive to the bark determination system, the stimulus delivery device delivering a corrective stimulus to the dog upon a positive bark determination. The corrective stimulus can be one of an electrostatic shock, an ultrasonic pulse, an irritant, a vibration, a spray, and an audible deterrent.

The bark determination system includes a plurality of microphones positioned about the neck of the dog for sampling a sound emitted by the dog. At least one microphone can be positioned to face inward, towards the neck of the dog and at least one microphone can be positioned to face outward, away from the neck of the dog. A processing unit is used to determining whether the sound detected by the inwardly and outwardly facing microphones represents a bark from the dog. The processing unit utilizes the sound level, duration and frequency of the sound detected by the inwardly and outwardly facing microphones.

In making the bark determination, the level of the sound detected by the inwardly facing microphone is compared to a first threshold sound level and the level of the sound detected by the outwardly facing microphone is compared to a second threshold sound level. If either the level of the sound detected by the inwardly microphone is less than the first threshold sound level or the level of the sound detected by the outwardly facing microphone is less than the second threshold sound level then a negative bark determination made.

If both of the above conditions as met, the frequency and durations of the sound are validated. The frequency of the sound detected by the inwardly facing microphone is compared to an acceptable frequency range and the duration of the sound detected by the inwardly facing microphone is compared to an acceptable duration. If the frequency of the sound detected by the inwardly facing microphone in not within the acceptable frequency range or the duration of the sound detected by the inwardly facing microphone is less than the acceptable duration then a negative bark determination is made.

Similarly, the frequency of the sound detected by the outwardly facing microphone is compared to an acceptable frequency range and the duration of the sound detected by the outwardly facing microphone is compared to an acceptable duration. If the frequency of the sound detected by the outwardly facing microphone in not within the acceptable frequency range or the duration of the sound detected by the outwardly facing microphone is less than the acceptable duration then a negative bark determination is made.

If the above condition are met, then a positive bark determination can be made if one of the following conditions is met:

The frequency of the sound detected by the inwardly facing microphone is equal to the frequency of the sound detected by the outwardly facing microphone;
a) the frequency of the sound detected by the inwardly facing microphone is greater than the frequency of the sound detected by the outwardly facing microphone, and the frequency of the sound detected by the inwardly facing microphone is less than twice the frequency of the sound detected by the outwardly facing microphone; or
b) the frequency of the sound detected by the inwardly microphone is less than the frequency of the sound detected by the outwardly facing microphone, and the frequency of the sound detected by the outwardly facing microphone is less than twice the frequency of the sound detected by the inwardly microphone.

If none of the above conditions are met, a negative bark determination is made.

It will be appreciated by persons skilled in the art that the preset invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

### BRIEF DESCRIPTION OF THE DRAWINGS

A more complete understanding of the preset invention, and the attendant advantages and features thereof, will be more readily understood by reference to the following detailed description when considered in conjunction with the accompanying drawings wherein:

FIG. 1 depicts a block diagram of the bark control system of the preset disclosure;

FIG. 2 depicts an operational flow diagram of the bark control system of the preset disclosure;

FIG. 3 depicts an exemplary signal diagram illustrating the output signals of the amplifiers and threshold detectors of the bark control system;

FIG. 4 depicts a block diagram of an alternative bark control system of the preset disclosure

FIG. 5 depicts a front isometric view of a housing for the bark control system;

FIG. 6 depicts a rear view of a housing for the bark control system;

FIG. 7 depicts a bark control system configured to provide a electro-shock corrective stimulus;

FIG. 8 depicts a bark control system configures to provide an audible or ultra-sonic corrective stimulus; and

FIG. 9 depicts a block diagram of the bark control system of the preset disclosure including a power management system.

### DETAILED DESCRIPTION OF THE INVENTION

The preset disclosure provides a collar mounted bark control device which is positionable about the neck of a dog. The bark control device includes a collar with a housing mounted thereto. The housing contains a power source such as a battery or the like. Microphones are positioned on the housing for detecting the sound produced by the dog while barking. A processing unit (CPU) is provided for receiving the signals from the microphones for making a bark determination. A corrective stimulus is applied to the dog when the CPU makes a positive bark determination. The corrective stimulus can be provided by a pair of electrodes for applying an electroshock to the neck of the dog. Alternatively, the corrective stimulus can be provided by a high frequency emitter, a vibration, a spray, an audible deterrent, or an irritant to the dog.

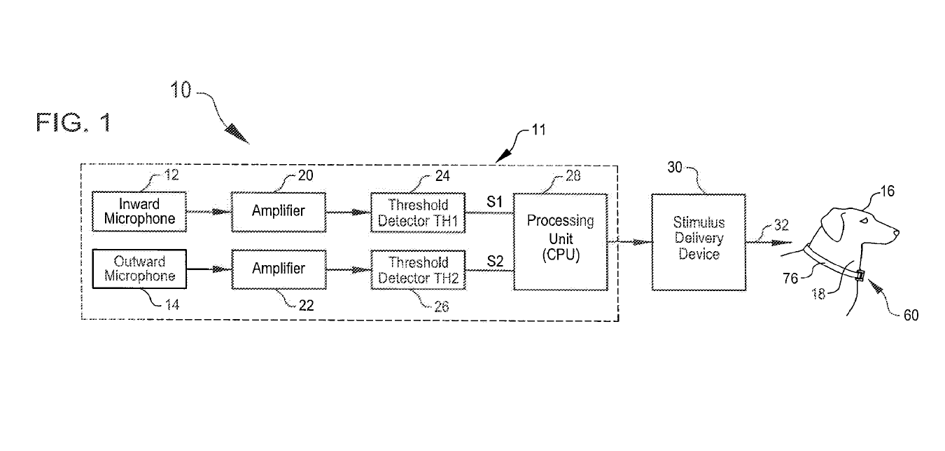

Referring now to the drawing figures in which like reference designators refer to like elements, there is shown in FIG. 1 a block diagram of a bark control system 10. The bark control system 10 includes a bark determination system 11 and a stimulus delivery device 30. The bark determination system 11 has at least one inwardly facing microphone 12 and an outwardly facing microphone 14 positioned to detect when the dog 16 barks. The inwardly facing microphone 12 is positioned to face inward, towards, but spaced from, the neck 18 of the dog 16. The outwardly facing microphone(s) 14 is positioned to face outward, away from the neck 18 of the dog 16, The output of both the inwardly facing and outwardly facing microphones 12 and 14 are amplified by amplifiers 20 and 22, and otherwise conditioned, before being passed to threshold detectors 24 and 26. The threshold detectors 24 and 26 compared the signals to preset thresholds TH1 and TH2, respectively.

The output signal from the inwardly facing microphone 12 is compared to a first preset threshold TH1. If the signal from the inwardly facing microphone 12 is greater than the first preset threshold TH1 the threshold detector 24 transmits a signal S1 to the processing unit (CPU) 28. Simultaneously, the output signal from the outwardly facing microphone 14 is compared to a second preset threshold TH2. If the signal from the outwardly facing microphone 14 greater than the preset threshold TH2 the threshold detector 26 transmits a signal S2 to the CPU 28.

The CPU 28 makes a bark determination based on the received signals S1 and S2. If the CPU 28 makes a positive bark determination, a signal is sent to the stimulus delivery device 30. Upon receipt of a positive bark determination, the stimulus delivery device 30 applies a corrective stimulus 32 to the dog 16. The corrective stimulus 32 can take the form of an electrostatic shock, an ultrasonic pulse, a vibration, a spray, an audible deterrent, or an irritant to the dog 16.

The intensity of the corrective stimulus 32 provided by the stimulus delivery devise 30 can have multiple intensity levels between a minimum intensity level and a maximum intensity level. The stimulus delivery devise 30 can vary the intensity levels of corrective stimulus 32 between the minimum and a maximum intensity level through a predetermined sequence upon each successive application of said corrective stimulus within a predetermined time period. Alternatively, the intensity level can be selectable by the dog owner, being manually set between the minimum and a maximum intensity levels.

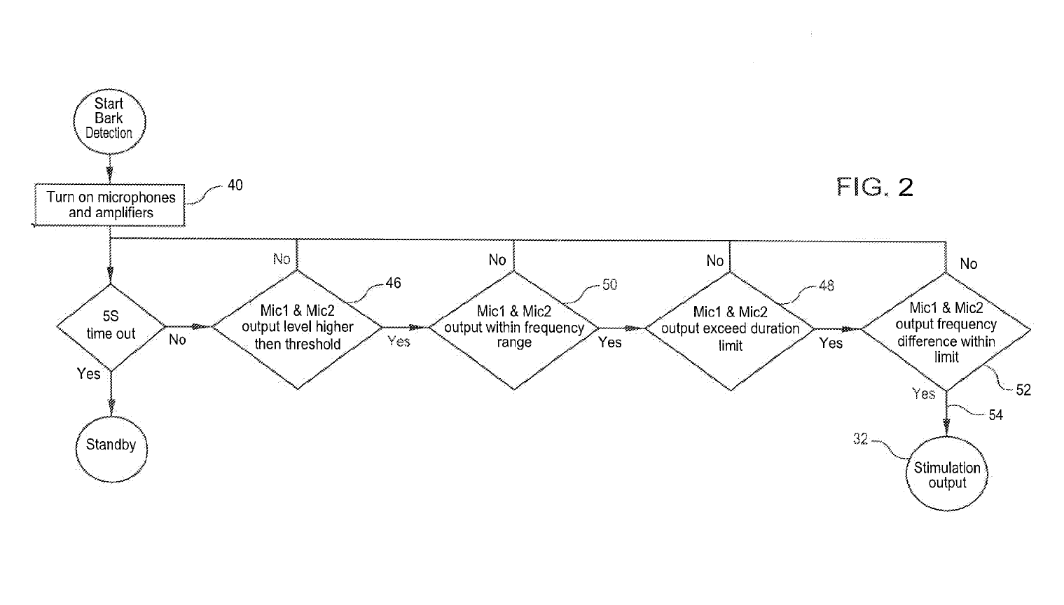

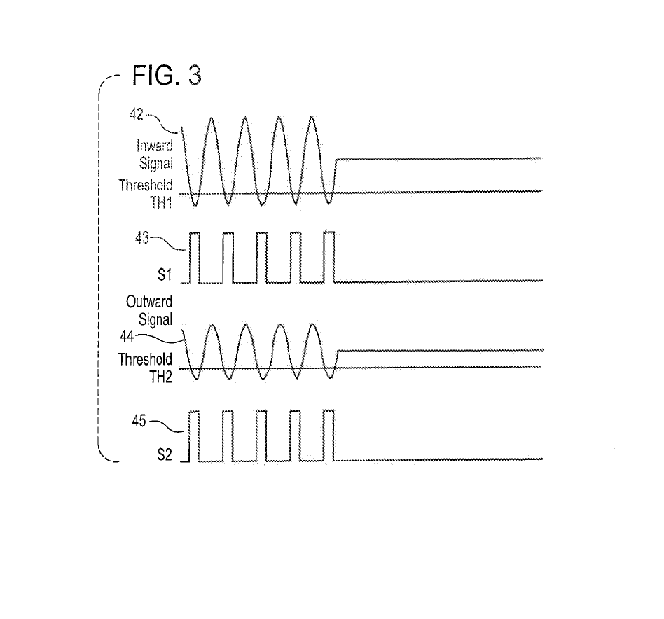

Referring to FIGS. 2 and 3, an operational flow of the bark control system 10 is provided. Upon initiation 40, the bark determination system 11 will make a bark determination based on a number of factors, including, the sound levels, frequency, and durations of the output signals from the amplifiers 20 and 22 and the threshold detector 24 and 26.

Upon receiving a sound the inwardly facing and outwardly facing microphones 12 and 14 each transmit a signal to the amplifiers 20 and 22, respectively. The amplified signals 42 and 44 are transmitted to the threshold detectors 24 and 26. The threshold detectors 24 and 26 determine 46 if each of the amplified signals 42 and 44 are greater than, have a sufficient sound level, the preset threshold sound levels TH1 and TH2. For example, if the amplified signal 42 from the inwardly facing microphone 12 has a sound level above about 108 dBA, the signal S1 43 is outputted to the CPU 28. If the amplified signal 44 from, the second microphone 14 has a sound level above about 86 dBA, the signal S2 45 is outputted to the CPU 28. It should be noted that the above sound levels are only exemplary, and it is contemplated that other sound levels by be used.

As an initial threshold, both the amplified signals 42 and 44 from the inwardly facing and outwardly facing microphones 12 and 14 must be greater than the preset thresholds TH1 and TH2, respectively. If either one of the amplified signals 4.2 and 44 is less than the preset thresholds TH1 and TH2, respectively, a negative bark determination is made.

If both the amplified signals 42 and 44 are greater than the preset thresholds TH1 and TH2, respectively, output signals S1 43 and S2 45 are sent to the CPU 28. The CPU 28 makes a bark determination base on the output signals S1 43 and S2 45. The CPU 28 compares the duration 48 and frequency 50 of the output signal S1 43 and S2 45 to preset durations and frequencies.

The CPU 28 will check the frequency and duration of signal S1 43. The duration shall exceed a preset time, T_{b}, for example 70 mSec, and the frequency shall be between Freq_Lo and Freq_Hi, for example 1.00 Hz to 2 Khz. If both of these conditions are not met, a negative bark determination is made.

The CPU 38 will check the frequency and duration of signal S2 45. The duration shall exceed a preset time, T_{b}, for example 70 mSec, and the frequency shall be between Freq_Lo and Freq_Hi, for example 100 Hz to 2 Khz. If both of these conditions are not met, a negative bark determination is made.

If both signal S143 and S2 45 are verified by the CPU 28, the CPU 28 with compare 52 the frequency signals S1 43 and S2 45 to each other. The comparison 52 of signals S1 43 and S2 45 provides a verification that the signals S1 43 and S2 45 are from the same source. In the comparison 52, S1 43 and S2 45 shall meet one of the following relationships:
a) Frequency S1=S2
b) If the frequency S1>S2 and S1<2×S2
c) If the frequency S1<S2 and S2<2×S1

At least one of the above conditions must be met, else a negative bark determination is made. If at least one of the above conditions is met, a signal 54 is provided to the stimulus delivery device 30 to provide a corrective stimulus 32 to the dog 16. The corrective stimulus 32 can take the form of an electrostatic shock, an ultrasonic pulse, a vibration, a spray, an audible deterrent, or an irritant to the dog 16.

In the above description, the bark detection system is described as have a single inwardly facing microphone 12. However, it is contemplated that the bark detection system can have a plurality of inwardly facing microphones.

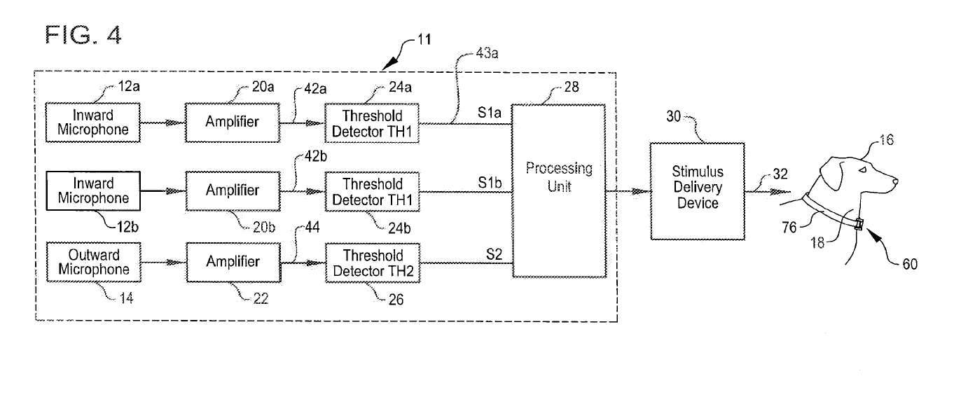

Referring to FIG. 4 an alternative block diagram of the bark control system 10 is provided. The bark control system 10 includes a bark determination system 11 and a stimulus delivery device 30. The bark determination system 11 has a pair of inwardly facing microphone 12a and 12b and an outwardly facing microphone 14 positioned to detect when the dog 16 barks. The inwardly facing microphones 12a and 12b are positioned to face inward, towards, but spaced from, the neck 18 of the dog 16. The outwardly facing microphone(s) 14 is positioned to face outward, away from the neck 18 of the dog 16. The output of the inwardly facing microphones 12a and 12b and outwardly facing microphone 14 are amplified by amplifiers 20a, 20b, and 22, and otherwise conditioned, before being passed to threshold detectors 24a, 24b, and 26. The threshold detectors 24a, 24b, and 26 compared the signals to preset thresholds TH1, TH1, and TH2.

The output signal from the inwardly lacing microphone 12a is compared to a first preset threshold TH1. If the signal from the inwardly facing microphone 12a is greater than the first preset threshold TH1 the threshold detector 24 transmits a signal S1a to the processing unit (CPU) 28.

Simultaneously, the output signal from the inwardly facing microphone 12b is compared to a first preset threshold TH1. If the signal from the inwardly facing microphone 12b is greater than the first preset threshold TH1 the threshold detector 24 transmits a signal S1b to the processing unit (CPU) 28.

The output signal from the outwardly facing microphone 14 is compared to a second preset threshold TH2. If the signal from the outwardly facing microphone 14 greater than the preset threshold TH2 the threshold detector 26 transmits a signal S2 to the CPU 28.

The CPU 28 makes a bark determination based on the received signals S1a, S1b, and S2. If the CPU 28 makes a positive bark determination, a signal is sent to the stimulus delivery device 30. Upon receipt of a positive bark determination, the stimulus delivery device 30 applies a corrective stimulus 32 to the dog 16, The corrective stimulus 32 can take the form of an electrostatic shock, an ultrasonic pulse, a vibration, a spray, an audible deterrent, or an irritant to the dog 16.

The intensity of the corrective stimulus 32 provided by the stimulus delivery devise 30 can have multiple intensity levels between a minimum, intensity level and a maximum intensity level. The stimulus delivery devise 30 can vary the intensity levels of corrective stimulus 32 between the minimum and a maximum intensity level through a predetermined sequence upon each successive application of said corrective stimulus within a predetermined time period. Alternatively, the intensity level can be selectable by the dog owner, being manually set between the minimum and a maximum intensity levels.

In an embodiment of multiple inwardly facing microphone system, the operational flow is similar to that provided in FIGS. 2 and 3. Upon initiation 40, the bark determination system 11 will make a bark determination based on a number of factors, including, the sound levels, frequency, and durations of the output signals from the amplifiers 20a, 20b, and 22 and the threshold detector 24a, 24b, and 26.

Upon receiving a sound the inwardly facing and outwardly facing microphones 12a, 12b, and 14 each transmit a signal to the amplifiers 20a, 20b, and 22, respectively. The amplified signals 42a, 42b, and 44 are transmitted to the threshold detectors 24a, 24b, and 26. The threshold detectors 24a, 24b, and 26 determine 46 if each of the amplified signals 42a, 42b, and 44 are greater than, have a sufficient sound level, the preset threshold sound levels TH1 and TH2. For example, if the amplified signal 42a from the inwardly facing microphone 12a has a sound level above about 108 dBA, the signal S1a 43b is outputted to the CPU 28, and if the amplified signal 42b from the inwardly facing microphone 12b has a sound level above about 108 dBA, the signal S1b 43b is outputted to the CPU 28. If the amplified signal 44 from the second microphone 14 has a sound level above about 86 dBA, the signal S2 45 is outputted to the CPU 28. It should be noted that the above sound levels are only exemplary, and it is contemplated that other sound levels by be used.

As an initial threshold, the amplified signals 42a and 42b from the outwardly facing microphones 12a and 12b must each be greater than the preset threshold TH1 and the amplified signals 44 from the inwardly facing microphone 14 must be greater than the preset threshold TH2. If either one of the amplified signals 42a, 42b, or 44 is less than the preset thresholds TH1 and TH2, respectively, a negative bark determination is made.

If all the amplified signals 42a, 42b, and 44 are greater than the preset thresholds TH1 and TH2, output signals S1a 43a, S1b 43b, and S2 45 are sent to the CPU 28. The CPU 28 makes a bark determination base on the output signals S1a 43a, S1b 43b, and S2 45. The CPU 28 compares the duration 48 and frequency 50 of the output signal S1a 43b, S1b 43b, and S2 45 to preset durations and frequencies.

The CPU 28 will check the frequency and duration of signal S1a 43a. The duration shall exceed a preset time, T_{b}, for example 70 mSec, and the frequency shall be between Freq_Lo and Freq_Hi, for example 100 Hz to 2 Khz. If both of these conditions are not met, the signal S1a 43a fails to meet the positive bark determination requirements.

The CPU 28 will check the frequency and duration of signal S1b 43b. The duration shall exceed a preset time, T_{b}, for example 70 mSec, and the frequency shall be between Freq_Lo and Freq_Hi, for example 100 Hz to 2 Khz. If both of these conditions are not met, the signal S1b 43b fails to meet the positive bark determination requirements.

In an embodiment, if either the signals S1a 43a or S1b 43b fails to meet the positive bark determine requirements, then a negative bark determination is made. Alternatively, if at least one of the signals S1a 43a or S1b 43b meets both of the conditions, then negative bark determination is not made at this stage.

The CPU 38 will check the frequency and duration of signal S2 45. The duration shall exceed a preset time, T_{b}, for example 70 mSec, and the frequency shall be between Freq_Lo and Freq_Hi, for example 100 Hz to 2 Khz. If both of these conditions are not met, a negative bark determination is made.

If the signals S1a 43a and/or S1b 43b, and S2 45 are verified by the CPU 28, the CPU 28 with compare 52 the frequency of signals S1a 43a and S1b 43B to the frequency of S2. The comparison 52 of signals S1a 43a and/or S1b 43b to S2 45 provides a verification that the signals S1a 43a and/or S1b 43b and S2 45 are from the same source. In the comparison 52, S1a 43a and/or S1b 43b and S2 45 shall one of the following relationships:
a) Frequency S1a=S2
b) If the frequency S1a>S2 and S1a<2×S2
c) If the frequency S1a<S2 and S2<2×S1a and/or
d) Frequency S1b=S2
e) If the frequency S1b>S2 and S1b<2×S2
f) If the frequency S1b<S2 and S2<2×S1b

At least one of the above conditions must be met for signal S1a 43a and S1b 43b, else a negative bark determination is made. If at least one of the above conditions is met, a signal 54 is provided to the stimulus delivery device 30 to provide a corrective stimulus 32 to the dog 16. The corrective stimulus 32 can take the form of an electrostatic shock, an ultrasonic pulse, a vibration, an audible deterrent, or an irritant to the dog 16.

Alternatively, at least one of the above conditions must be met for signal S1a 43a or S1b 43b, else a negative bark determination is made. If at least one of the above conditions is met, a signal 54 is provided to the stimulus delivery device 30 to provide a corrective stimulus 32 to the dog 16. The corrective stimulus 32 can take the form of an electrostatic shock, an ultrasonic pulse, a vibration, an audible deterrent or an irritant to the dog 16.

In another embodiment, as an initial threshold, at least one of the amplified signals 42a and 42b from the outwardly facing microphones 12a or 12b must be greater than the preset threshold TH1 and the amplified signals 44 from the inwardly facing microphone 14 must be greater than the preset threshold TH2. If both of amplified signals 42a and 42b are less than the preset thresholds TH1, or the amplified signal 44 is less than the preset thresholds TH2, a negative bark determination is made.

If at least one of the amplified signals 42a and 42b is greater than the preset threshold TH1, and amplified signal 44 is greater than the preset threshold TH2, output signals S1a 43a and/or S1b 43b and S2 45 are sent to the CPU 28. The CPU 28 makes a bark determination base on the output signals S1a 43a and/or S1b 43b, and S2 45. The CPU 28 compares the duration 48 and frequency 50 of the output signal S1a 43b and/or S1b 43b and S2 45 to preset durations and frequencies.

If the signal S1a 43a was sent to the CPU 28 the CPU 28 will check the frequency and duration of signal S1a 43a. The duration shall exceed a preset time, T_{b}, for example 70 mSec, and the frequency shall be between Freq_Lo and Freq_Hi, for example 100 Hz to 2 Khz. If both of these conditions are not met, the signal S1a 43a fails to meet the positive bark determination requirements.

If the signal S1b 43b was sent to the CPU 28 the CPU 28 will check the frequency and duration of signal S1b 43b. The duration shall exceed a preset time, T_{b}, for example 70 mSec, and the frequency shall be between Freq_Lo and Freq_Hi, for example 100 Hz to 2 Khz. If both of these conditions are not met, the signal S1b 43b fails to meet the positive bark determination requirements.

If at least one of the signals S1a 43a or S1b 43b meets both of the conditions, then negative bark determination is not made at this stage. The CPU 38 will check the frequency and duration of signal S2 45. The duration shall exceed a preset time, T_{b}, for example 70 mSec, and the frequency shall be between Freq_Lo and Freq_Hi, for example 100 Hz to 2 Khz. If both of these conditions are not met, a negative bark determination is made.

If the signals S1a 43a and/or S1b 43b, and S2 45 are verified by the CPU 28, the CPU 28 with compare 52 the frequency of signals S1a 43a and S1b 43B to the frequency of S2. The comparison 52 of signals S1a 43a and/or S1b 43b to S2 45 provides a verification that the signals S1a 43a and/or S1b 43b and S2 45 are from the same source. In the comparison 52, S1a 43a and/or S1b 43b and S2 45 shall one of the following relationships:
a) Frequency S1a=S2
b) If the frequency S1a>S2 and S1a<2×S2
c) If the frequency S1a<S2 and S2<2×S1a and/or
d) Frequency S1b=S2
e) If the frequency S1b>S2 and S1b<2×S2
f) If the frequency S1b<S2 and S2<2×S1b

At least one of the above conditions must be met for signal S1a 43a or S1b 43b, else a negative bark determination is made. If at least one of the above conditions is met, a signal 54 is provided to the stimulus delivery device 30 to provide a corrective stimulus 32 to the dog 16. The corrective stimulus 32 can take the form of an electrostatic shock, an ultrasonic pulse, a vibration, an audible deterrent, or an irritant to the dog 16.

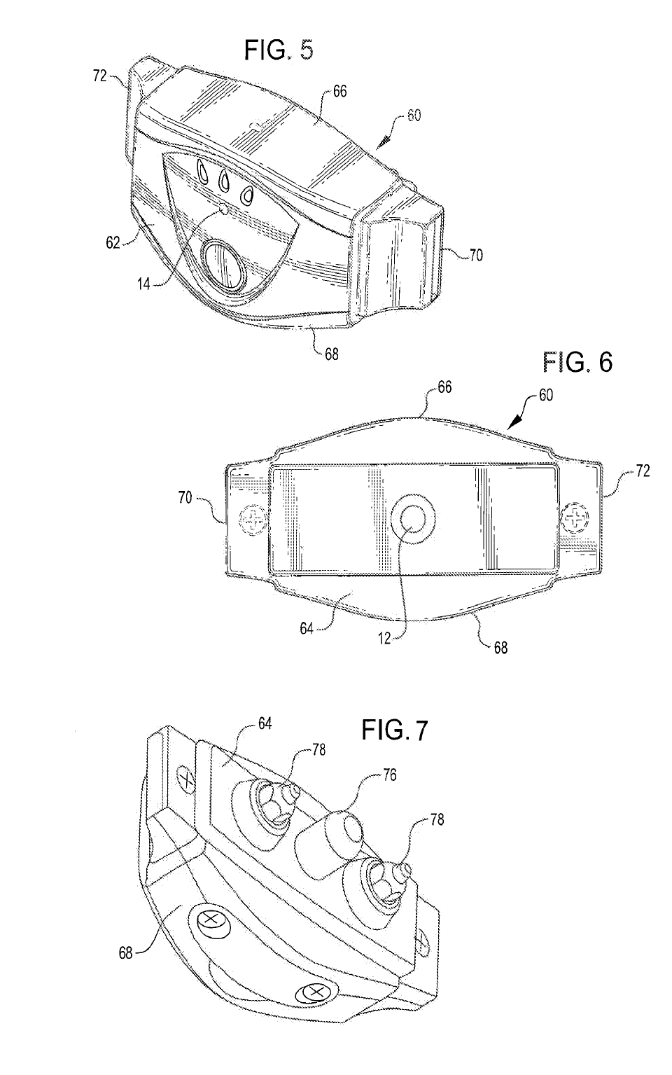

In an embodiment, a shown in FIGS. 5 and 6 a housing 60 for the bark control system 10 is provided. The housing 60 includes a front surface 62, back surface 64, top and bottom surfaces 66 and 68, and a pair of side surfaces 70 and 72. A collar 74 can be mounted to the side surfaces 70 and 72 to allow for placement about the neck 18 of the dog 16. The second microphone 14 is positioned on the front surface 62 of the housing 60, outwardly facing from the neck 18 of the dog 16. The first microphone 12 is positioned on the back surface 64 of the housing 60, inwardly facing the neck 18 of the dog 16. A hollow tube 76 can be positioned on the first microphone 12, spacing the first microphone 12 from the neck 18 of the dog 16 (see FIG. 6).

In the above embodiment, the first microphone 12 is shown positioned on the back surface 64 of the housing 60. However, it is contemplated that the first microphone 12 can be provided in alternative positions, as long as the microphone 12 is facing inward, towards the neck 18 of the dog 16. Such alternative position can include, on the sides 66 and 68 of the housing or on the collar 74.

Referring to FIG. 7 a bark control system 10 configured to apply an electrostatic shock is provided. Terminal posts 78 extend from the back surface 64 of the housing 60 for transferring an electrostatic shock corrective stimulus to the dog 16.

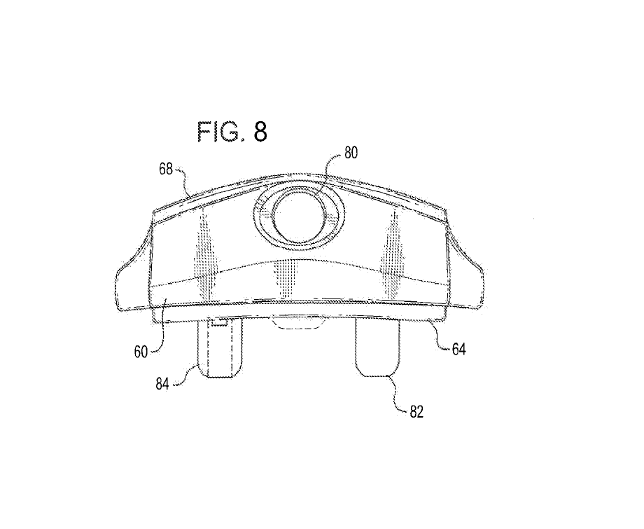

Referring to FIG. 8, a bark control system 10 configured to apply an audible deterrent or an ultrasonic pulse corrective stimulus is provided. A speaker 80 is positioned on the housing 60 for transferring an audible deterrent or an ultrasonic pulse corrective stimulus corrective stimulus to the dog 16. Spacer 82 and 84 can be position on the back surface 64 of the housing 60. The spacers 82 and 84 can provide the function of aiding in the positioning of the housing 60 on the neck 18 of the dog 16, and spacing the first microphone 12 from the neck 18 of the dog 16. In such a configuration, at least one of the spacers 82 or 84 is a hollow tube positioned over the first microphone 12.

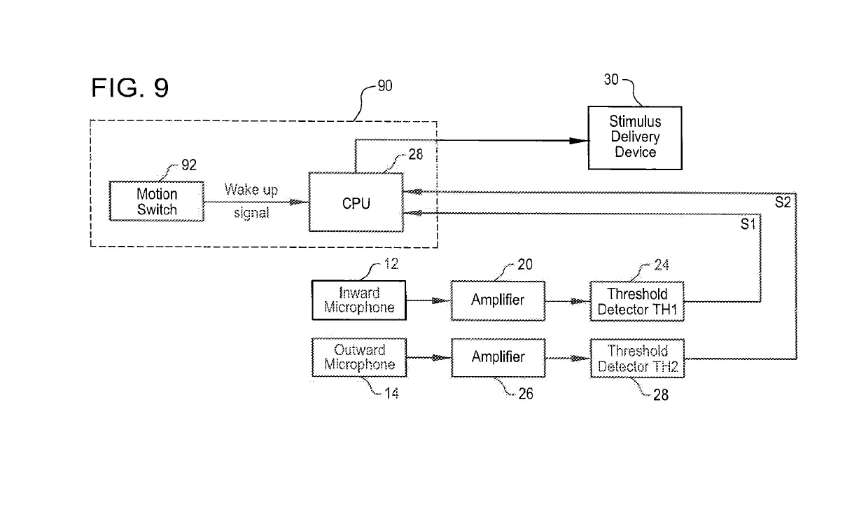

Referring to FIG. 9, a block diagram of the bark control system 10 including a power management system is provided. The bark control system 10 is the same as provided in FIG. 1, with the inclusion of the power management system 90. The power management system 90 can include the CPU 28 and a motion sensor 92. In use, when the neck/head 18 of the dog 16 is not exhibiting the pre-described motion for a preset period of time the CPU 28 places the bark detection system 11 in a sleep mode, removing power there from. Upon detecting a motion from the neck/head 18 of the dog 18, the motion sensor 92 provides a “wake up” signal to the CPU 28. In response, the CPU 28 places the bark determination system 11 in an “active mode,” providing power to the bark determination system 11. It is envisioned that in order for the motion sensor 92 to detect a motion, the motion should be a sudden jerking motion, sudden increase in acceleration, of the neck 18 of the dog 16. In is also noted that the motion sensor 92 is not used in marking the bark determination.

While a preferred embodiment has been shown and described, it will be understood that it is not intended to limit the disclosure, but rather it is intended to cover all modifications and alternate methods falling within the spirit and the scope of the invention as defined in the appended claims

All references cited herein are expressly incorporated by reference in their entirety.

All references cited herein are expressly incorporated by reference in their entirety.

It will be appreciated by persons skilled in the art that the preset invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed:

1. A bark control device for training a dog not to bark comprising:
a housing:
a mounting device for attaching the housing to about a neck of the dog;
a first microphone carried by the housing for sampling a sound emitted by the dog;
a second microphone carried by the housing for sampling the sound emitted by the dog;
a processing unit carried by the housing for determining whether the sound detected by the first and second microphones represent a bark from the dog; and
a stimulus delivery device responsive to the processing unit, the stimulus delivery device carried by the housing for delivering a corrective stimulus to the dog upon a positive bark determination.

2. The bark control device as set forth in claim 1, wherein the first microphone is positioned to face inwardly, towards the neck of the dog.

3. The bark control device as set forth in claim 2, wherein the second microphone is positioned to face outwardly, away from the neck of the dog.

4. The bark control device as set forth in claim 1, further comprising a motion senor, wherein the motion sensor activates the first and second microphone upon a detection of a motion of the neck of the dog.

5. The bark control device as set forth in claim 4, wherein the bark determination is made independently of the motion sensor.

6. The bark control device as set forth in claim 1, wherein the corrective stimulus includes at least one of an electrostatic shock, an ultrasonic pulse, an irritant, a vibration, a spray and an audible deterrent.

7. A bark control device for training a dog not to bark comprising:
a housing;
a mounting device for attaching the housing to about a neck of the clog; a bark determination system; and
a stimulus delivery device carried by the housing and responsive to the bark determination system, the stimulus delivery device delivering a corrective stimulus to the dog upon a positive bark determination.

8. The bark control device as set forth in claim 7, further comprising a power management system.

9. The bark control device as set forth in claim 8, wherein the power management system includes a motion sensor.

10. The bark control device as set forth in claim 8, wherein the bark determination system operates independently of the power management system.

11. The bark control system a set forth in claim 7, wherein the bark determination system comprises:
a first microphone for sampling a sound emitted by the dog;
a second microphone for sampling the sound emitted by the dog; and
a processing unit for determining whether the sound detected by the first and second microphones represent a bark from the dog.

12. The bark control system as set forth in claim 11, wherein the first microphone is positioned to face inwardly, towards the neck of the dog, and the second microphone is positioned to face outwardly, away from the neck of the dog.

13. The bark control system as set forth in claim 11, wherein the bark determination system comprises a first threshold detector operably connected to the first microphone and a second threshold detector operably connected to the second microphone.

14. The bark control system as set forth in claim 11, wherein the bark determination system makes a bark determination based on a level, frequency, and duration of a sound detected by the first microphone and a level, frequency, and duration of a sound detected by the second microphone.

15. The bark control system as set forth in claim 7, wherein the corrective stimulus includes at least one of an electrostatic shock, an ultrasonic pulse, an irritant, a vibration, a spray, and an audible deterrent.

16. A method a making a bark determination comprising:
providing a bark control device positionable on a dog, and including:
a first microphone facing inwardly towards the dog
a second microphone facing outwardly from the dog, and
a processing unit for determining whether a sound detected by the first and second microphones represent a bark from the dog;
positioning the bark control device on a neck of the dog;
detecting a sound with the first microphone, wherein the sound has a sound level, a frequency, and a duration;
detecting the sound with the second microphones, wherein the sound has a sound level, a frequency, and a duration;
comparing the level of the sound detected by the first microphone to a first threshold sound level;
comparing the level of the sound detected by the second microphone to a second threshold sound level;
comparing the frequency of the sound detected by the first microphone to an acceptable frequency range:
comparing the frequency of the sound detected by the second microphone to the acceptably frequency range;
comparing the duration of the sound detected by the first microphone to an acceptable duration;
comparing the duration of the sound detected by the second microphone to the acceptable duration; and
comparing the frequency of the sound detected by the first microphone to the frequency of the sound detected by the second microphone.

17. The method, of making a bark determination as set forth in claim 16, further comprising making a negative bark determination if either:
the level of the sound, detected by the first microphone is less than the first threshold sound level; or
the level of the sound, detected by the second microphone is less than the second threshold sound level.

18. The method of making a bark determination as set. forth in claim 17, further comprising making a negative bark determination if either:
the frequency of the sound detected by the first microphone in not within the acceptable frequency range; or
the duration of the sound detected by the first microphone is less than the acceptable duration.

19. The method of making a bark determination as set forth in claim 18, further comprising making a negative bark determination if either:
the frequency of the sound detected by the second microphone in not within the acceptable frequency range; or
the duration of the sound detected by the second microphone is less than the acceptable duration.

20. The method of making a bark determination as set forth in claim 19, further comprising making a positive bark determination if one of the following conditions is met:
the frequency of the sound detected by the first microphone is equal to the frequency of the sound detected by the second microphone;
the frequency of the sound detected by the first microphone is greater than the frequency of the sound detected by the second microphone, and the frequency of the sound detected by the first microphone is less than twice the frequency of the sound detected by the second microphone; or
the frequency of the sound detected by the first microphone is less than the frequency of the sound detected by the second microphone, and the frequency of the sound detected by the second microphone is less than twice the frequency of the sound detected by the first microphone.
